(19) United States
(12) Patent Application Publication
(10) Pub. No.: US 2005/0282424 A1
(43) Pub. Date: Dec. 22, 2005

(54) Electrical connector with latching device

(75) Inventors: Shang-Yen Huang, Taipei Hsien (TW); Sheng-Ho Yang, Taipei Hsien (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/011,105

(22) Filed: Dec. 15, 2004

(30) Foreign Application Priority Data
Jun. 18, 2004 (TW) 093209645

(51) Int. Cl. H01R 13/627

(52) U.S. Cl. 439/353

(57) ABSTRACT

An electrical connector assembly comprises a first connector including a latching device, a metal case, a plastic housing, and a first conductor assembly; and a second connector coupled to one end of the first connector. The latching device comprises a structure including an insulative base, a support, and a second conductor assembly, and two U-shaped flexible members each including a bent member and an arm. The base comprises a top slot on either side, and a recess below either slot. The support comprises two elongate grooves at both sides with the top slots and the recesses of the base secured to the grooves of the support when the support and the base are coupled together. The second connector comprises an opening at one end for locking the latching device. The invention can lower the possibility of signal disruption due to excessive plugging/unplugging.

### BACKGROUND OF THE INVENTION

1. Field of the Invention

The present invention relates to electrical connectors and more particularly to a mini-USB (Universal Serial Bus) type electrical connector having a latch device with improved characteristics.

2. Description of Related Art

Reliable securing of an electrical connector in a port or to a mated connector is very important. For example, a mini-USB type electrical connector comprises a projection (or so-called male connector) and a port (or so-called female connector). Each of the male and female connectors comprises an insulative body, a conductor assembly in the body, and a metal housing for enclosing the body.

However, the coupled male and female connectors tend to become loose because for example the male connector, attached to a cable, is provided externally to a coupled device and is thus subject to disengagement by pulling the cable. This can cause a poor electrical contact. It is understood that the times of plugging and/or unplugging the mini-USB type electrical connector is larger than that of a typical electrical connector. Thus, the mini-USB type electrical connector incorporating the conventional construction cannot ensure a reliable connection because a resilient member of the male connector may suffer elastic fatigue after a predetermined number of times of use and the coupling of the male and female connectors may be compromised by inadvertently pulling the cable. Thus, continuing improvements in the exploitation of electrical connector are constantly being sought.

### SUMMARY OF THE INVENTION

It is an object of the present invention to provide an electrical connector having a latching device constructed by utilizing the principles of leverage so that the electrical connector can be secured to a mated connector.

It is another object of the present invention to provide an electrical connector having a reliable, durable latching device so that an inadvertent pulling of the cable coupled to the electrical connector will not compromise the electrical connection of the coupled electrical connector and the mated connector.

To achieve the above and other objects, the present invention provides an electrical connector assembly comprising a first connector including a latching device, a metal case, a plastic housing, and a first conductor assembly; and a second connector coupled to one end of the first connector, wherein the latching device comprises a structure including an insulative base, a support, and a second conductor assembly, and two U-shaped flexible members each including a bent member and a resilient arm, wherein the insulative base comprises a top slot provided on either side, and a recess formed below either slot; wherein the support comprises two elongate grooves at both sides with the top slots and the recesses of the insulative base secured to the grooves of the support when the support and the insulative base are coupled together; and wherein the second connector comprises an opening at one end for locking the latching device.

The above and other objects, features and advantages of the present invention will become apparent from the following detailed description taken with the accompanying drawings.

### BRIEF DESCRIPTION OF THE DRAWINGS

FIG. 1 is an exploded perspective view of a preferred embodiment of electrical connector assembly according to the invention;

FIG. 2 is a perspective view of the assembled electrical connector assembly;

FIG. 3 is an exploded view of the electrical connector assembly;

FIG. 4 is a detailed exploded view of the latching device shown in FIG. 3;

FIG. 5 is another detailed exploded view of the latching device shown in FIG. 3 viewed from an opposite angle;

FIG. 6 is a detailed exploded view of the housing shown in FIG. 3; and

FIG. 7 is a detailed exploded view of the second connector shown in FIG. 3.

### DETAILED DESCRIPTION OF THE PREFERRED EMBODIMENTS

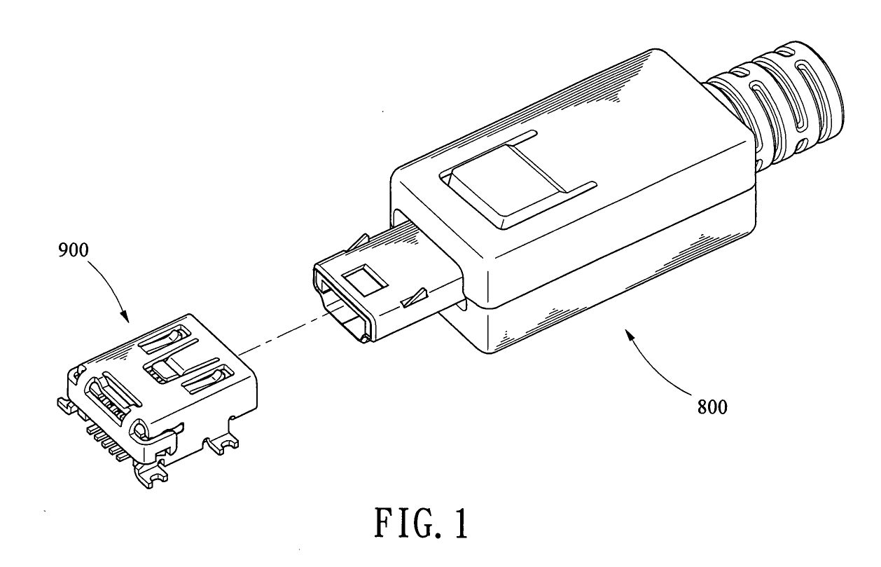

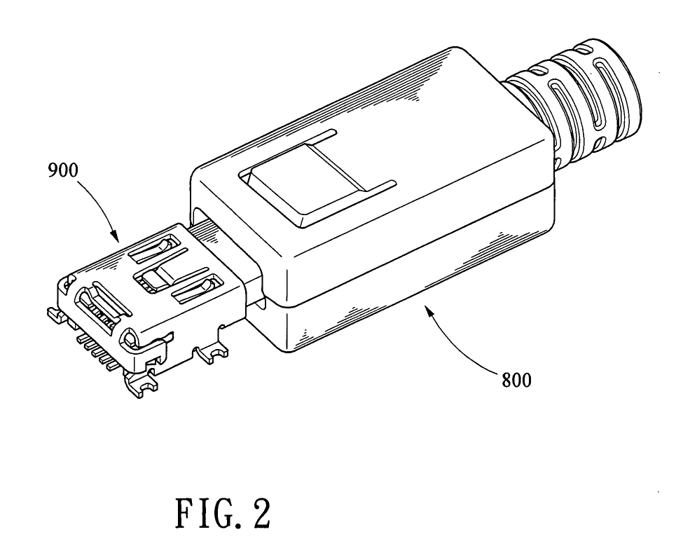

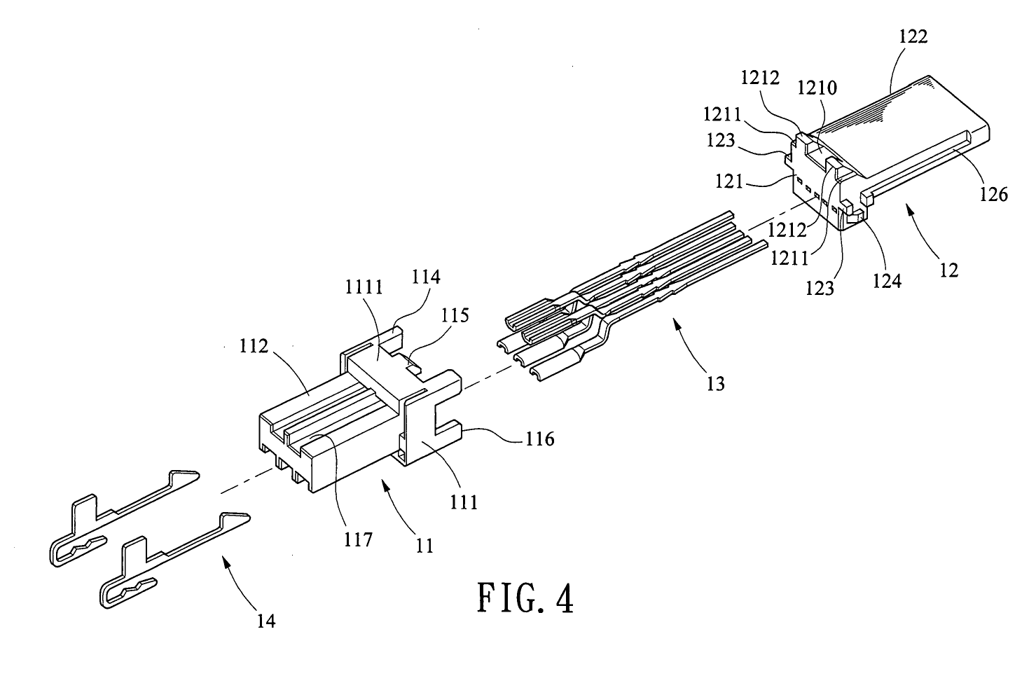

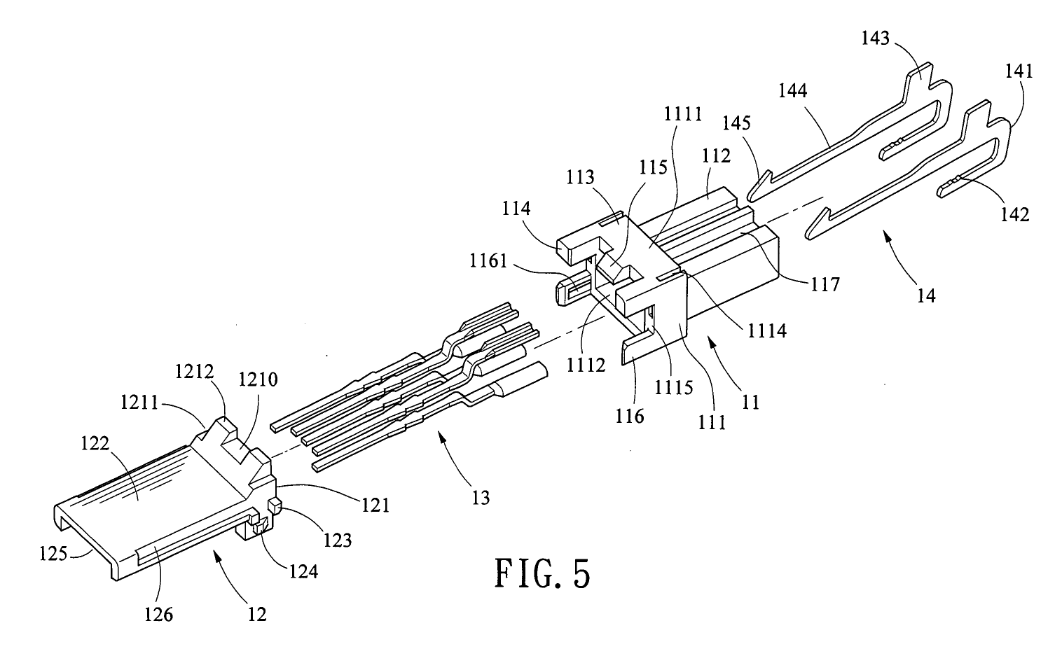

Referring to FIGS. 1 to 5, there is shown an electrical connector assembly constructed in accordance with a preferred embodiment of the invention. The electrical connector assembly comprises a first connector 800 coupled to a cable at one end and a second connector 900 coupled to the other end of the first connector 800. The first connector 800 comprises a latch device 10, a metal case member 20, a plastic housing 30, and a cable enlargement 40. The latch device 10 comprises an insulative base 11, a support 12, a conductor assembly 13, and two U-shaped flexible members 14. The case member 20 comprises an inner case member 21 and an outer case member 22. The housing 30 comprises an upper shell 31 and a lower shell 32.

A structure 15 is comprised of the insulative base 11, the support 12, and the conductor assembly 13 of the latching device 10. The structure 15 is a well known device and is provided only for cooperating with the flexible members 14. Thus, a detailed description thereof is omitted herein for the sake of brevity. The base 11 is a substantially elongate member and comprises an enlarged body 111 and a connecting member 112 opposite the enlarged body 111. The enlarged body 111 comprises a connecting element 1111 and a cavity 1112 in communication with a plurality of parallel top channels 117 of the connecting member 112. The conductor assembly 13 is received in the cavity 1112. Two upper projections 114 are provided at both sides of the connecting element 1111. A protrusion 115 is provided between the upper projections 114. On the top of the support 12, an intermediate dent 1210, two side indentations 1211, and two projections 1212 each sandwiched between the indentations 1211 and the dent 1210 are provided at one end thereof. These components 1210, 1211, and 1212 are matingly coupled to the upper projections 114 and the protrusion 115 when the base 11 and the support 12 are coupled and fastened together. Two lower projections 116 are provided at both sides of the connecting element 1111. The lower projection 116 comprises an inner tunnel 1161. A slot 1114 is provided on either side of a top 113 of the connecting element 1111. A recess 1115 is formed between the upper and lower projections 114 and 116. The recess 1115 is in communication with the tunnel 1161. As such, two bent members 141 of the flexible members 14 are adapted to secure to the recesses 1115 and two protuberances 143 of the flexible members 14 are adapted to fasten within the slots 1114 when the flexible members 14 and the base 11 are coupled together.

The support 12 and the conductor assembly 13 of the latch device 10 are formed integrally by insert molding. The support 12 comprises a rear seat 121 and a front plate 122. Both a projection 123 and an adjacent tab 124 are provided at either side of the rear seat 121. The tabs 124 are snugly received in the tunnel 1161 for securing the support 12 to the base 11. The front plate 122 comprises an underside trough 125 for receiving the conductor assembly 13 and two elongate grooves 126 at both sides for permitting resilient arms 144 and latched members 145 of the flexible members 14 to place thereon.

The flexible members 14 are adapted to cooperate with the structure 15 and each comprises a bent member 141, a toothed member 142 on a short branch thereof for positioning in the tunnel 1161, the protuberance 143 on a long branch thereof adjacent the bent member 141, the arm 144 on the long branch thereof, and the latched member 145 at an open end of the arm 144. In response to inserting the flexible members 14 in the base 11, the protuberances 143 are fastened in the slots 1114, and the arms 144 pass the recesses 1115 to dispose on the grooves 126. A user may manipulate the latched members 145 to secure the flexible members 14 to the base 11 or disengage the flexible members 14 therefrom.

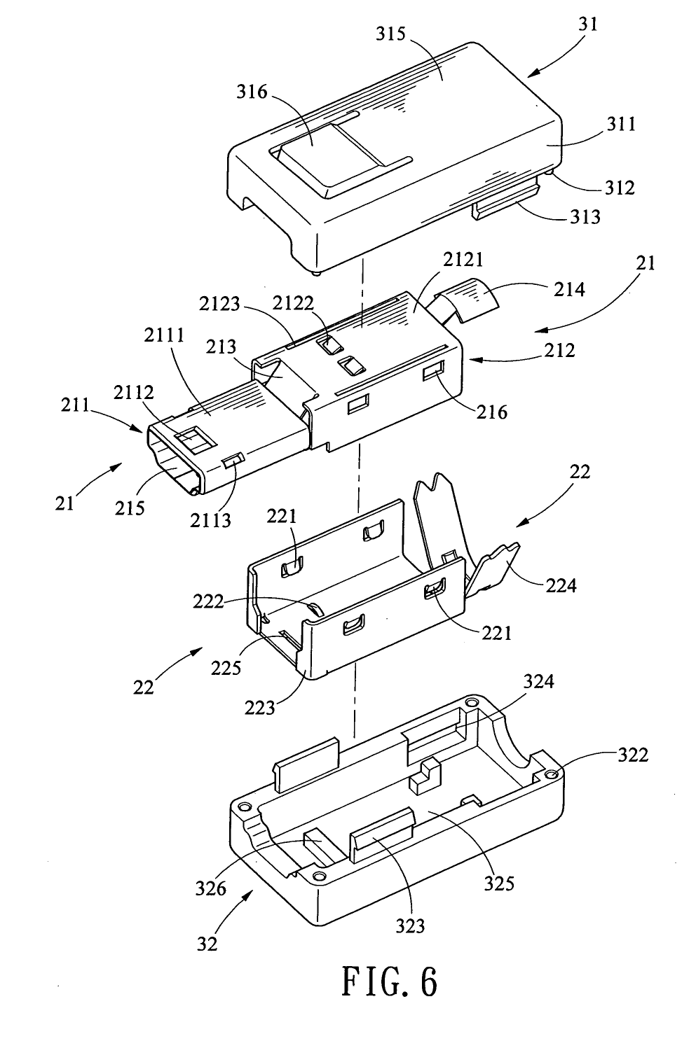

Referring to FIG. 6, the case member 20 comprises the inner case member 21 and the outer case member 22. The inner case member 21 comprises a front member 211, a rear member 212, and a ramp 213 for connecting the front and rear members 211 and 212 together. An arcuate member 214 is extended from one end of the rear member 212. A space 215 is defined by the front member 211 to receive the support 12. An opening 2112 is provided on a top 2111 of the front member 211. A slit 2113 is provided at either side edge of the front member 211. The arms 144 pass the grooves 126 to cause the latched members 145 to insert through the slits 2113 to project from the front member 211. A transverse rib (not shown) is provided on an underside of the front member 211 to insert in a slit 225 of the outer case member 22 for fastening both the inner and outer case members 21 and 22 together. The rear member 212 is a case element and comprises two latches 2122 on a top 2121 thereof. A latch 2122 is provided along either top edge of the rear member 212 for positioning the protuberance 143. Two openings 216 are provided on either side of the rear member 212. Two latches 221 are provided on either side wall of the outer case member 22. The latches 221 are adapted to insert into the openings 216 for fastening the inner and outer case members 21 and 22 together.

A plurality of tabs 222 are provided on a bottom of the outer case member 22. The tab 222 are urged against a bottom of the base 11 for fastening the base 11 in the outer case member 22. A space is defined by two opposite front members 223 and is adapted to substantially conform to and receive the front member 211 therein. A rear bent member 224 of the outer case member 22 is provided to cooperate with the arcuate member 214 to clamp the cable when the inner and outer case members 21 and 22 are coupled together.

The housing 30 is adapted to enclose the assembled case member 20. The upper shell 31 is a constructed to mating engage with the lower shell 32 and comprises a latch 313 extended downwardly from either side wall 311, four corner pegs 312, and two wells on both sides (not shown). The mated lower shell 32 comprises four corner holes 322 with the pegs 312 inserted thereinto, two upright latches 323 on both sides, and two wells 324 on both inner sides thereof. The latches 323 are adapted to insert in the wells of the upper shell 31 and the latches 313 are adapted to insert in the wells 324 of the lower shell 32 for fastening the shells 31 and 32 together. A latch 316 is formed on top 315 of the upper shell 31. A bar 326 is provided on bottom 325 of the lower shell 32. A pressing of the latch 316 will exert a force on the protuberances 143 and urge against the bar 326 such that the latching device 10 is prevented from being compromised due to excessive pressing. As a result, the electrical connector assembly can still maintain its quality after many times of plugging or unplugging.

Note that the cable enlargement 40 is a well known member. Thus, a detailed description thereof is omitted herein for the sake of brevity.

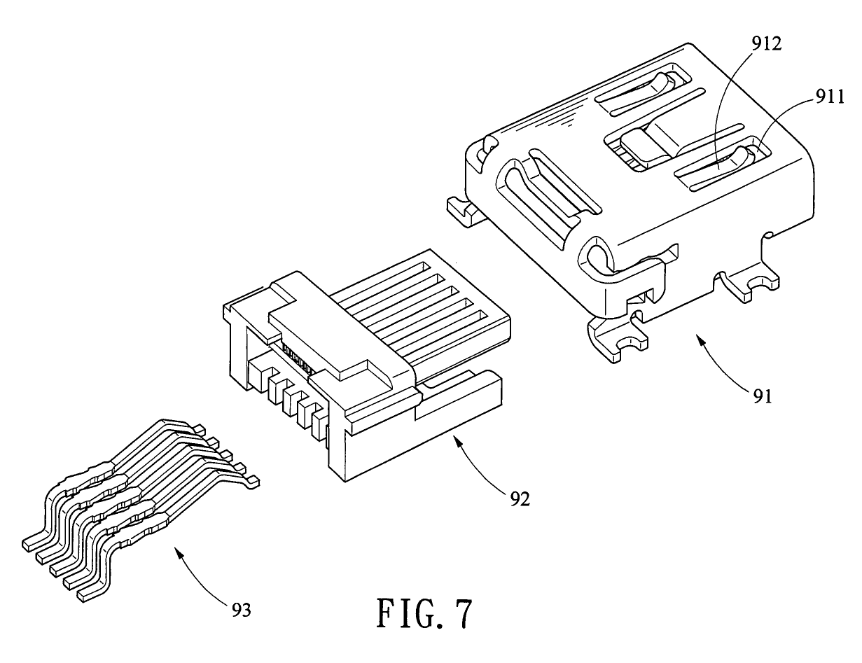

Referring to FIG. 7, the second connector 900 is adapted to couple to the first connector 800 and comprises an insulative seat 92, a conductor assembly 93, and a metal case 91. The case 91 comprises a plurality of slits 911 on an outer surface with a plurality of latches 912 projected therefrom (i.e., locked) when the second connector 900 and the first connector 800 are coupled together.

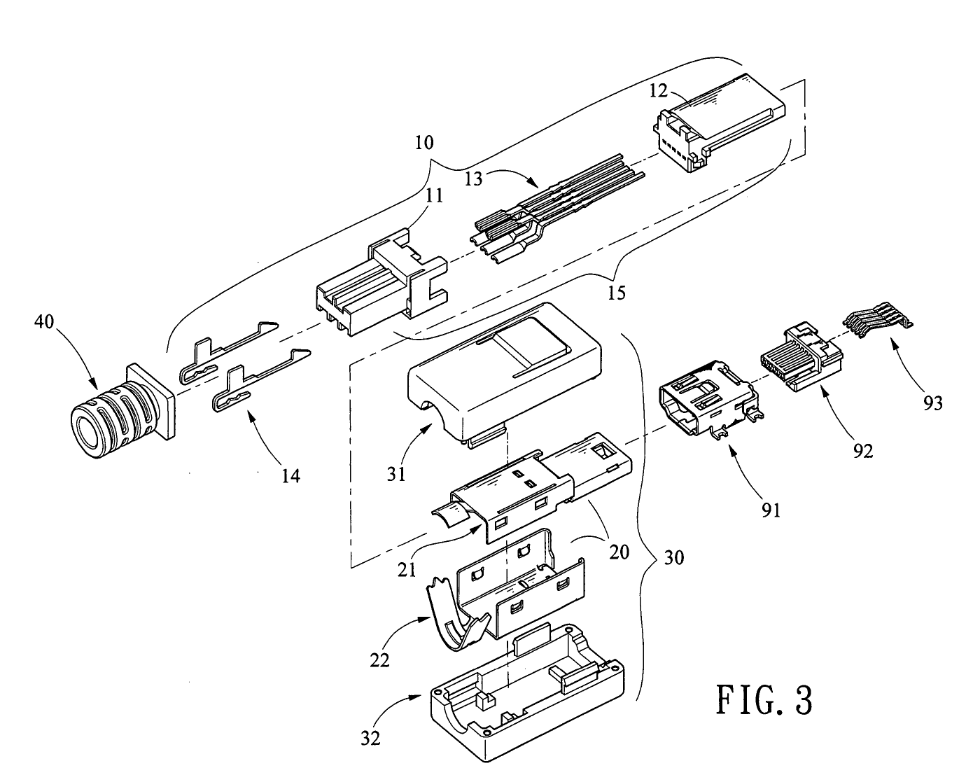

An assembly of the invention will be described in detailed below by referring to FIGS. 3 to 6 again. Firstly, insert the bent members 141 and the arms 144 of the flexible members 14 through the slots 1114 and the recesses 1115 with the latched member 145 projected and the bent members 141 fastened in the tunnels 1161. Next, urge the support 12 against the base 11 with the arms 144 disposed on the grooves 126. Also, the tabs 124 are inserted into the tunnels 1161 for fastening the support 12 and the base 11 together.

Secondly, couple the inner case member 21 and the above assembled components together. Then couple the inner case member 21 and the outer case member 22 together with the latches 221 and 2122 inserted into the openings 216 for fastening. Also, the latches 2122, 221 and the tabs 222 urge against the assembled components in the first stage. As such, these components are fastened within the case member 20.

Thirdly, enclose the assembled components in the second stage and the cable enlargement 40 in the housing 30 so as to fasten them together by snapping the upper shell 31 to the lower shell 32. At this position, the latches 316 are urged by the flexible members 14. This finishes the assembly of the invention as shown in FIG. 1.

The benefits of the invention include lowering the possibility of signal disruption due to excessive plugging/unplugging and increased communication quality.

While the invention herein disclosed has been described by means of specific embodiments, numerous modifications and variations could be made thereto by those skilled in the art without departing from the scope and spirit of the invention set forth in the claims.

1. An electrical connector assembly comprising:
a first connector including a latching device, a metal case, a plastic housing, and a first conductor assembly; and
a second connector coupled to one end of the first connector,
wherein the latching device comprises a structure including an insulative base (11), a support (12), and a second conductor assembly (13), and two U-shaped flexible members (14) each including a bent member (141) and a resilient arm (144), wherein the insulative base (11) comprises a top slot (1114) provided on either side, and a recess (1115) formed below either slot; wherein the support (12) comprises two elongate grooves (126) at both sides with the top slots (1114) and the recesses (1115) of the insulative base secured to the grooves of the support when the support and the insulative base are coupled together; and wherein the second connector comprises an opening at one end for locking the latching device.

2. The electrical connector assembly of claim 1, wherein the arm of the flexible member (144) comprises a protuberance (143) adjacent the bent member (141) and a latched member (145) at one end, and the bent member (141) of the flexible member comprises a toothed member (142).

3. The electrical connector assembly of claim 2, wherein the insulative base (11) further comprises an enlarged body (111), a connecting member (112) opposite the enlarged body, the enlarged body including a connecting element (1111) and a cavity (1112) in communication with a plurality of parallel top channels (117) of the connecting member (112) and being adapted to receive the conductor assembly (13), and two upper projections (114) provided at both sides of the connecting element (1111), a protrusion (115) provided between the upper projections (114), and two lower projections (116) provided at both sides of the connecting element (1111), either lower projection including an inner tunnel (1161), a slot (1114) provided on either side of a top of the connecting element wherein the bent members (141) of the flexible members (14) are adapted to secure to the recesses (1115) and the protuberances (143) of the flexible members are adapted to fasten within the slots (1114) of the insulative base (11) when the flexible members (14) and the insulative base (11) are coupled together; and the support (12) further comprises, at one end of a top, an intermediate dent (1210), two side indentations (1212), and two projections (1212) each sandwiched between the side indentation (1211) and the intermediate dent (1210) wherein the intermediate dents (1210), the side indentations (1211), and the projections (1212) are matingly coupled to the upper projections (114) and the protrusion (115) when the insulative base (11) and the support (12) are fastened together

4. The electrical connector assembly of claim 1, wherein the case member comprises an inner case member (21) including a rear member (212), a front member (211), and a ramp (213) interconnected the front and the rear members, and an outer case member (22), wherein the front member (211) comprises a space (215) to receive the support (12), a slit: (2113) provided at either side edge for permitting the latched (145) member of the flexible member (14) to insert through and project from the case member, and a transverse rib provided on an underside of the front member (211) inserted in a slit (225) of the outer case member (22) for fastening both the inner and outer case members together, and the outer case member (22) is mated with the inner case member (21) and comprises two latches (221) at either side, a plurality of tabs (222) on a bottom urged against the insulative base (11), and a front space defined by two opposite front members (223) adapted to substantially conform to and receive the front member (211) of the inner case member (21) therein.

5. The electrical connector assembly of claim 1, wherein the housing comprises an upper shell and a mated lower shell, wherein the upper shell comprises a latch (313) extended downwardly from either side wall, four corner pegs (312), and two wells (311) on both sides, and the lower shell comprises four corner holes (322) with the pegs (312) of the upper shell inserted thereinto, two upright latches (323) on both sides, and two wells (321) on both sides, and wherein the latches (323) of the lower shell are adapted to insert in the wells (311) of the upper shell and the latches (313) of the upper shell (31) are adapted to insert in the wells (321) of the lower shell (32) for fastening the shells together, further comprising a latch (316) formed on a top of the upper shell and a bar (326) formed on a bottom of the lower shell, the bar (326) being adapted to urge against the top latch (313) of the upper shell.

6. The electrical connector assembly of claim 3, wherein the support (12) and the second conductor assembly (13) of the latching device are formed integrally by insert molding.

7. The electrical connector assembly of claim 2, wherein the toothed (142) member of the flexible member is adapted to secure to the tunnel (1161).
